(19) United States
(12) Patent Application Publication
(10) Pub. No.: US 2010/0308031 A1
(43) Pub. Date: Dec. 9, 2010

(54) Apparatus and Method for Producing Transformation of A Three Dimensional Object

(76) Inventor: Suzanne Brown, Tucson, AZ (US)

Correspondence Address: LAWRENCE R. OREMLAND, P.C., 5055 E. BROADWAY BLVD., SUITE C-214, TUCSON, AZ, 85711, US

(21) Appl. No.: 12/795,653

(22) Filed: Jun. 7, 2010

Related U.S. Application Data
(60) Provisional application No. 61/184,591, filed on Jun. 5, 2009.

(51) Int. Cl. A21B 1/00

(52) U.S. Cl. 219/400

(57) ABSTRACT

A new and useful apparatus and method is provided for producing transformation of a three dimensional object, e.g. a child's craft object, by application of heat to the object. The object is preferably a non edible, transformable product configured to change state and/or appearance when heated.

### RELATED APPLICATION/CLAIM OF PRIORITY

This application is related to and claims priority from provisional application Ser. No. 61/184591, filed Jun. 5, 2009, and entitled “Toy Oven”, which provisional application is incorporated herein by reference.

### INTRODUCTION

The present invention relates to new and useful apparatus and method for producing transformation of a three dimensional object, e.g. a child's craft object, by application of heat to the object. The object is preferably a non edible, transformable product configured to change state and/or appearance when heated.

A provisional application, Ser. No. 61/184,591, filed Jun. 5, 2009, and entitled Toy Oven discloses and claims many of the aspects of applicant's apparatus and method, and that provisional application is incorporated by reference herein. Moreover, applicant has attached (as Exhibit A) an edited version of that application that applicant believes improves the description of those aspects of applicant's invention. Also, applicant has presented claims 1-7 below, and has presented in Exhibit A additional claims 8-31) that are edited from the claims of application Ser. No. 61/184,591 in a manner intended to make such claims 8-31) part of the claim set of this application.

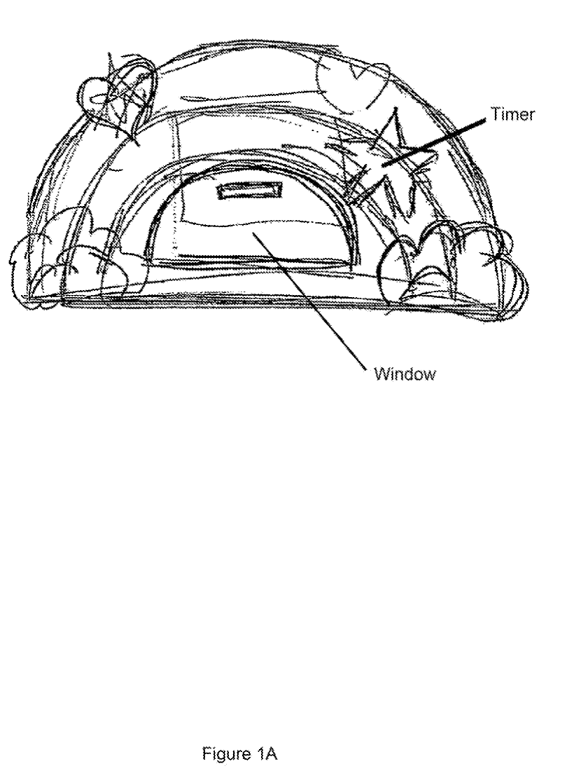

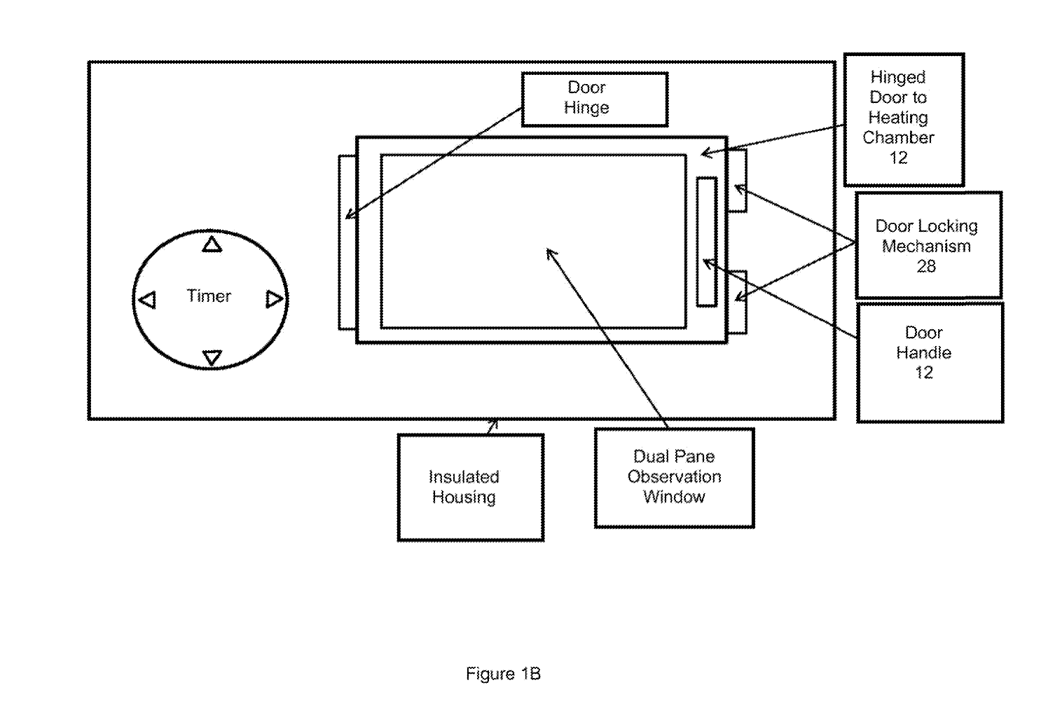

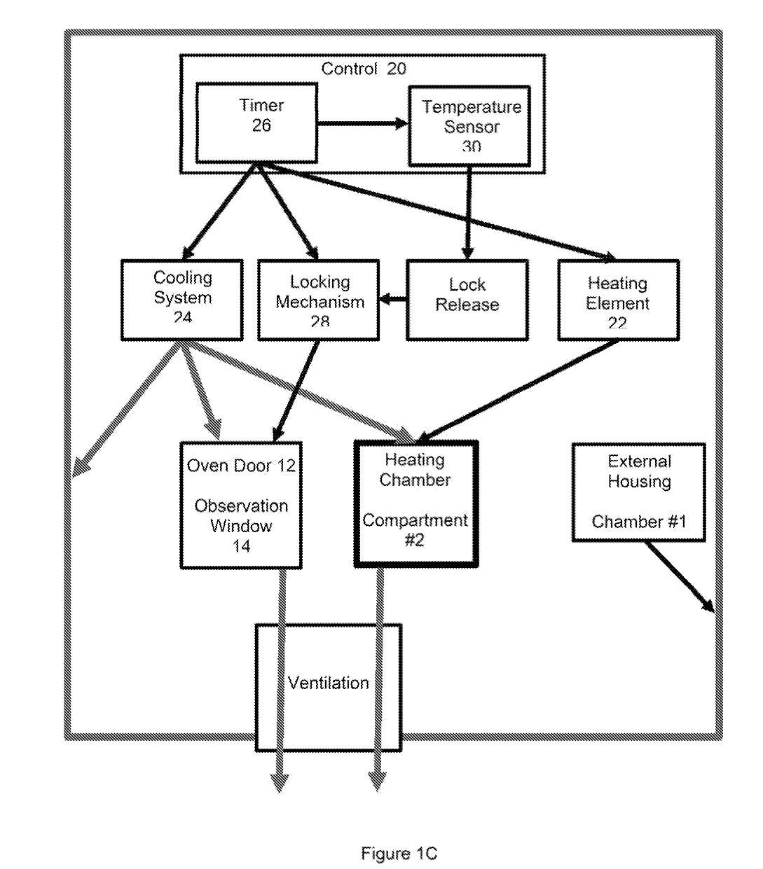

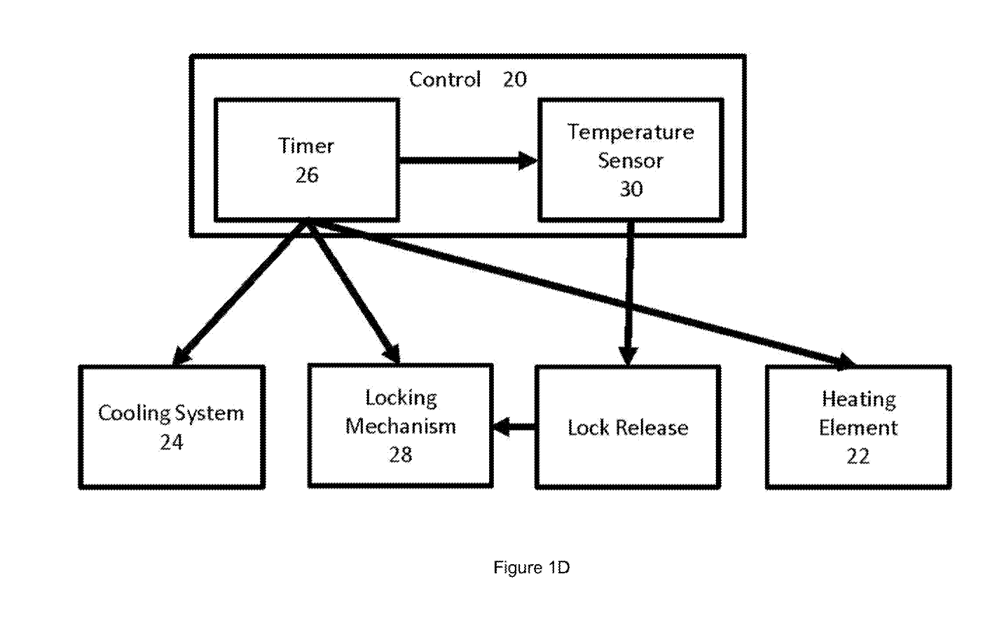

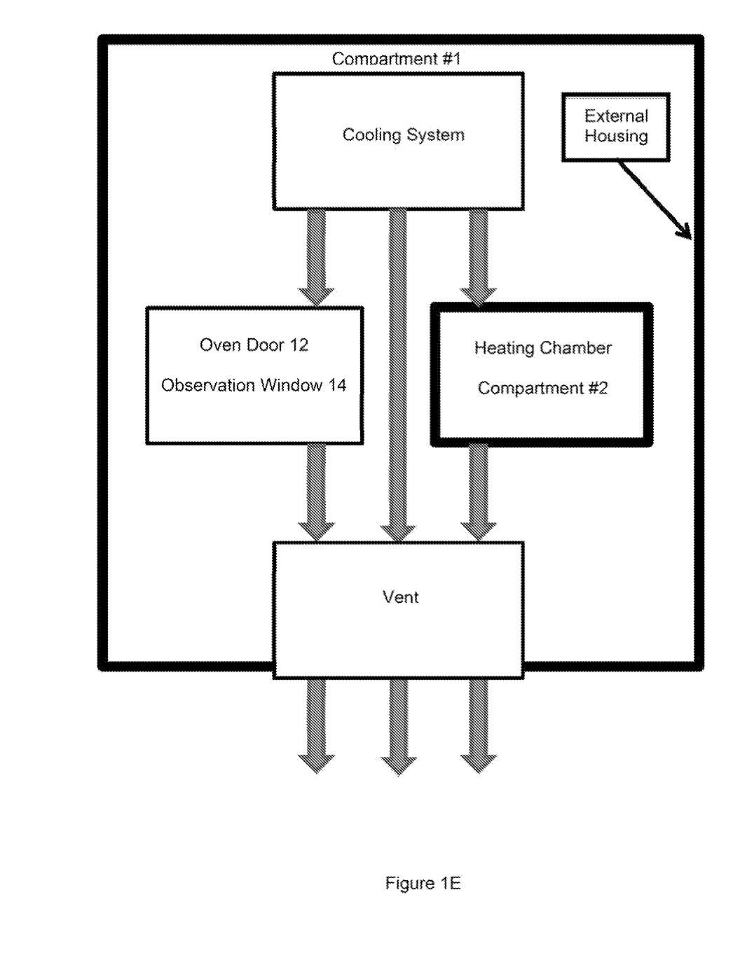

This application further describes applicant's invention, including a summary of features of applicant's invention described herein, FIGS. 1A-1E which illustrate and describe a preferred location for a window in applicant's invention and schematics relating to applicant's process, and additional background describing other products on the market at the time of creation of applicant's invention and the manner in which the present invention was conceived. Applicant believes these materials, along with the attached edited version of application Ser. No. 61/184591, will enable one skilled in the art to fully appreciate applicant's invention.

### SUMMARY OF APPLICANT'S INVENTION CLAIMED HEREIN

An important aspect of applicant's invention described and claimed herein is a new and useful apparatus and process for providing a transformation of a non edible, transformable product configured to change state and/or appearance when heated. A toy oven is provided that includes
a. an insulated housing and a heating chamber disposed within the housing,
b. a broadband source (preferably an incandescent light source) located within the housing to provide a source of radiation for heating and for illuminating the heating chamber,
c. the insulated housing having an opening through which a product can be manually inserted into or removed from the heating compartment, the opening being large enough for insertion and withdrawal of a human hand,
d. a door configured to be selectively opened when a product is being manually inserted into the heating compartment and closed when a product is located in the heating compartment,
e. a window configured and located (preferably in the door) to enable the product to be viewed while in the heating compartment, the window having an outer surface on the outer surface of the oven, and
f. a fan for producing a fluid flow that cools the outside surface of the window when a product is being heated in the heating chamber, and that cools the heating chamber after a predetermined heating cycle for a product in the heating chamber.

The non edible, transformable product is configured to change state and/or appearance when heated in the heating chamber, and which is safe enough to be handled by a child for extraction from the heating chamber and when out of the heating chamber.

Initially, the non edible transformable product is manually inserted into the heating chamber, then the door is closed (and latched, so that it cannot be opened by a child). Then, the broadband incandescent light source is turned on (preferably under the control of a timer) to provide a heating cycle in which the heating chamber is heated and illuminated, and a fluid flow is produced from the fan to cool the outer surface of the window while the heating chamber is being heated, whereby the non edible transformable product will undergo a change of state and/or appearance within the heating chamber, that can be viewed through the window. After a predetermined heating cycle for the product, the broadband incandescent light source is turned off to discontinue production of heat in the heating chamber, and fluid flow from the fan is directed to cool the heating chamber. The door is maintained latched for a period of time after the broadband incandescent light source has been turned off to enable the heating chamber to cool to a predetermined extent. Then, the door is allowed to be opened, to enable a transformed product to be manually extracted from the heating chamber through the opening.

Preferably, the opening in the insulated housing has a minimum size of at least 3 inches (in this application: “minimum size” means as the largest dimension of the opening that needs to accommodate insertion of a hand, e.g. if round the “minimum size” means the diameter, if square the “minimum size” means the length of a side, if rectangular “minimum size” means the height and/or length of the sides, etc). In addition, the heating chamber is configured with a volume such that it can support a three dimensional object having a height of at least 1.5 inches.

### BACKGROUND AND THE MANNER IN WHICH THE PRESENT INVENTION WAS CONCEIVED

There are several child safe toy ovens in the market place today. Generally they are related to baking a variety of foods and some limited non-food items. Each of these toy ovens is designed to minimize the ability for a child to place their hand inside the heating chamber even when the oven is in a cool state. The opening in the external housing does not have a door and is very low profile, no more than 1½″ tall by 4″ to 5″ long. The opening to the heating chamber is normally offset from the opening in the external housing by either a passageway through to the heating chamber or the external opening folds up closing off access to the heating chamber before it can be turned on. Both of these methods pose problems to the Applicant's invention, called the “Craft N Bake Oven,” due to the intended use evolving around crafting projects.

When I thought of the idea for the “Makit&Bakit” Oven (now known as the “Craft N Bake Oven”) I used Hasbro's “Easy Bake Oven” to try out a Makit&Bakit suncatcher project. Happily I found the “Easy Bake Oven” was successful in melting the plastic baking crystals. However I was unhappy with the final results. My finished Makit&Bakit Suncatcher was a mess. Let me explain:

The Makit&Bakit Suncatcher is a start to finish craft kit that contains an aluminum metal frame, a variety of colored plastic baking crystals and a pair of plastic tweezers to help you place the baking crystals strategically by color into the aluminum frame. The aluminum metal frame is made up of cavities so you can separate the colors and keep them from melting together. If and when you melt all colors together it normally ends up an ugly brown and you have no ability to see the natural design of the project. The end result is supposed to appear similar to a stained glass window.

When I used the Easy Bake Oven I used the baking pan that was included with the oven. I placed my metal frame into the pan and proceeded to place the plastic baking crystals individually by color into the separate cavities. It's like coloring a picture but you are using colored plastic chips instead of crayons. When I was done filling in the metal frame, I placed the pan into the opening of the external housing and pushed it into the heating chamber using the plastic tool provided with the oven. When I did this a good majority of the plastic baking crystals fell out of place mixing the different colors together. All my hard work was ruined. In some cases the baking crystals fell out of the cavity resulting in blank holes; in others the color mixed together resulting in the brown color I mentioned above.

Some of the issues and challenges from this initial test helped drive my claims for the patent of the Craft N Bake Oven. My first thought was if I could have seen what happened to the baking crystals before they started melting I may have been able to fix them. My second thought was even if I could see them I wouldn't have been able to access the pan until it was cool and it may have been too late to fix it anyway.

The difference between the conventional oven and the Easy Bake Oven is simply the way I placed the craft project into the heating chamber. I knew the Easy Bake Oven would melt the baking crystals but I couldn't stop the crystals from shifting ending in unfavorable results. When using a conventional oven I was able to place the project into the heating chamber very carefully with my hand. I didn't knock any of the baking crystals out of place, but if I did I also had the ability to reach inside the oven with my hand and fix any baking crystals that had fallen out before I turned the oven on.

That is when I knew the heating chamber needed to be big enough to allow me to place my craft projects inside by hand. The opening for the actual heating chamber needs to be a minimum of 1½″ inches in height but I wanted to make it as big as possible opening up the scope of different 3D projects I would be able to make. I knew the oven would not be successful if I limited it to flat projects only especially since crafting comes in all shapes and forms and I wanted the oven to be able to handle as many formats as possible. See my potential project list on the initial feature list I created. The metal frame for the suncatcher is only ⅛″ tall, but other projects I have in mind like paint and glaze ceramic figurines range in size. Some are as large as 2½″ to 4″ tall. These items need to be standing for the glaze to adhere in the heating process properly. Each project needs to be carefully placed in the oven by hand or the final results will be similar to my initial Makit&Bakit test. One scratch or nick could ruin the project. You also need the ability to reach in and straighten as I pointed out in the case of the Makit&Bakit project. The pass through method used in the Easy Bake Oven and the Creepy Crawler oven are not conducive to the type of crafting I want to introduce with the Craft N Bake oven.

Conclusions from my initial testing and keeping my product objectives in mind are:
Oven door needs to be hinged opening directly into the heating chamber
Heating chamber needs to have a big enough opening allowing a child to place the projects inside by hand.
Once the heating and cooling process has been completed, the child can reach into the oven to extract the finished work of art by hand.
The heating chamber is big enough so the child can view the project before closing the door to determine if the project is ready to begin the heating process.
Window in the door will allow the kids to monitor the progress inside the heating chamber and watch their craft project take its final form.

FIGS. 1A-1E schematically illustrate applicant's preferred location for the window (in the door), and the manner in which applicant's method is preferably performed.

Thus, as seen from the foregoing description and Exhibit A, applicant's invention provides a new and useful apparatus and process for providing a transformation of a non edible, transformable product configured to change state and/or appearance when heated. The scope of the invention presented herein is reflected in claims 1-7 below and claims 8-31 that are submitted in Exhibit A hereto.

1. A process for providing a transformation of a product, comprising,
A. providing a toy oven with
a. an insulated housing and a heating chamber disposed within the housing,
b. a broadband source located within the housing to provide a source of radiation for heating and for illuminating the heating chamber,
c. the insulated housing having an opening through which a product can be manually inserted into or removed from the heating compartment, the opening being large enough for insertion and withdrawal of a human hand,
d. a door configured to be selectively opened when a product is being manually inserted into the heating compartment and closed when a product is located in the heating compartment,
e. a window configured and located to enable the product to be viewed while in the heating compartment, the window having an outer surface on the outer surface of the heating chamber/oven, and
f. a fan for producing a fluid flow that cools the outside surface of the window when a product is being heated in the heating chamber, and that cools the heating chamber after a predetermined heating cycle for a product in the heating chamber;
B. providing a non edible, transformable product configured to change state and/or appearance when heated in the heating chamber, and which is safe enough to be handled by a child for extraction from the heating chamber and when out of the heating chamber,
C. manually inserting the non edible transformable product into the heating chamber,
D. thereafter closing the door, and
E. thereafter turning on the broadband source to provide a heating cycle in which the heating chamber is heated and illuminated, and producing fluid flow from the fan to cool the outer surface of the window while the heating chamber is being heated, whereby the non edible transformable product will undergo a change of state and/or appearance within the heating chamber, that can be viewed through the window,
F. turning off the broadband source after a predetermined heating cycle for the product to discontinue production of heat in the heating chamber, and causing fluid flow from the fan to cool the heating chamber,
G. maintaining the door locked for a period of time after the broadband source has been turned off to enable the heating chamber to cool to a predetermined value, and
H. thereafter allowing the door to be opened, to enable the transformed product to be manually extracted from the heating chamber through the opening.

2. The method of claim 1, wherein the opening in the insulated housing has a minimum size of at least 3 inches.

3. The method of claim 1, wherein the heating chamber is configured to support a three dimensional object having a height of at least 1.5 inches.

4. Apparatus for producing transformation of a product, comprising,
A. a non edible, transformable product configured to change state and/or appearance when heated in a heating chamber, and
B. a toy oven for heating the transformable product to produce the change of state and/or appearance of the product;
C. the toy oven comprising
a. an insulated housing and a heating chamber disposed within the housing,
b. a broadband source located within the housing to provide a source of radiation for heating and for illuminating the heating chamber,
c. the insulated housing having an opening through which a product can be manually inserted into or removed from the heating compartment, the opening being large enough for insertion and withdrawal of a human hand,
d. a door configured to be selectively opened when a product is being manually inserted into the heating compartment and closed when a product is located in the heating compartment,
e. a window configured and located to enable the product to be viewed while in the heating compartment, the window having an outer surface on the outer surface of the heating chamber/oven, and a fan configured to produce a fluid flow that cools the outside surface of the window when a product is being heated in the heating chamber, and that cools the heating chamber after a predetermined heating cycle for a product in the heating chamber.

5. The apparatus of claim 4, wherein the opening in the insulated housing has a minimum size of at least 3 inches.

6. The apparatus of claim 4, wherein the heating chamber is configured to support a three dimensional object having a height of at least 1.5 inches.

7. The apparatus of claim 4, wherein the window is formed in the door.
